(19) United States
(12) Patent Application Publication
(10) Pub. No.: US 2017/0251812 A1
(43) Pub. Date: Sep. 7, 2017

(54) Easel

(71) Applicant: Gregg Bjorn Thorkelsen, Herriman, UT (US)

(72) Inventor: Gregg Bjorn Thorkelsen, Herriman, UT (US)

(21) Appl. No.: 15/451,385

(22) Filed: Mar. 6, 2017

Related U.S. Application Data
(60) Provisional application No. 62/304,202, filed on Mar. 5, 2016.

(51) Int. Cl. A47B 97/08; F16B 2/00; F16B 2/12; F16B 1/00

(52) U.S. Cl. CPC A47B 97/08; F16B 1/00; F16B 2/005; F16B 2/12; F16B 2001/0035; F16B 2001/0028

(57) ABSTRACT

An easel is presented. The easel has a bottom and a top holder for holding a canvas, board, or other media for an artwork. The bottom and top holders are configured to be magnetically attached to a metal surface. The easel may have a rail on which the bottom and top holders may slide while attached to the surface. The rail may also have magnets to magnetically attach the rail to the surface. Alternatively, the metal surface may be an integral part of the rail or the rail may be made entirely of metal.

### RELATED APPLICATIONS

This Patent Application claims priority to the U.S. provisional patent application Ser. No. 62/304,202 entitled “EASEL” filed on Mar. 5, 2016 which is incorporated in its entirety by reference and made a part hereof.

### BACKGROUND OF THE INVENTION

Field of the Invention

The present invention relates to the easels for holding canvases and other media for creating works of art. More particularly the present invention relates to a customizable and reconfigurable easel.

State of the Art

Many artists are skilled in the various mediums of art. They may create unique and beautiful works of art such as drawings, paintings, or sculptures. Easels are often used by artists to hold canvasses, boards, or other media for creating artworks. Easels may come in a variety of shapes and sizes and generally are configured to be used with only a few sizes of canvases or boards. If the artist wants to use large canvases, a large easel is needed. A small easel is needed for smaller artworks. This can require the artist have a large under of easels to accommodate the projects they want to do.

Additionally, the artist may need a variety of tools, but keeping them readily accessible can be challenging. Some holders exist for tools such as brushes, knives, towels, and pallets. However they are often restricted on where these tools can be attached to an easel. Further the modern artist may also require a holder for photographs, tablet computers, screens, or other electronic displays.

### BRIEF SUMMARY OF THE INVENTION

An easel is presented. The easel may have top mount and a bottom mount for holding a canvass, board, or other media for an artwork. The top mount and the bottom mount may be magnetically attachable to a metal surface. The metal surface may have a metal such as iron, steel, nickel, or other metals or alloys that are attracted to magnets. The metal surface may be a metal door, a white board, a chalk board, a sheet of metal, a non-metal surface with metal imbedded in the surface or behind it, and the like. Likewise the surface may itself be magnetized.

For added stability the easel may have a rail and the top mount and the bottom mounts may have a groove configured to fit over the rail. Alternatively the surface may have a groove that can receive the top and bottom mounts.

In certain configurations the easel may have a first mount. The first mount may have a mount body and a mount ledge. The mount body may have a first magnet for securing the mount to the metal surface. If the metal surface of the easel is magnetized, the mount body may have metal that is attracted to the magnetized surface. A mount ledge may be configured to hold the media for the artwork. The mount ledge may protrude from the mount body and may also contain holders to securely grip the medium. In particular the mount ledge and the holder many be configured to hold an edge of the art work. A second magnet may be present within the mount body to further secure the mount to the metal surface.

A second mount may also be provided. The second mount may have a mount body and a mount ledge. The body of the second mount may have a first magnet for securing the mount to the metal surface. If the metal surface of the easel is magnetized, the mount body may have metal that is attracted to the magnetized surface. A mount ledge is ledge may be configured to hold the media for the artwork. The mount ledge may protrude from the mount body and may also contain holders to securely grip the medium. In particular the mount ledge and the holder many be configured to hold an edge of the art work. A second magnet may be present within the mount body to further secure the mount to the metal surface.

One or both of the magnets within the first and second mounts may be fixed strength magnets that have no means for varying the magnetic field exerted on the metallic surface. Alternatively, one or more of the magnets may be variable strength magnets that have means for varying the strength of the magnetic field exerted on metallic surface. Such variable strength magnets may be electromagnets, have means for cancelling the magnetic field, or means for mechanically separating the magnet from the metallic surface. Such variable strength magnets may have a magnet attached to a threaded stem and a threaded housing for receiving the threaded stem. The magnetic field exerted on the metallic surface may be varied by turning the magnetic stem to separate the magnet from the metallic surface.

In certain embodiments, the easel may have a rail. The metal surface may be embedded in the rail, the metal surface may surround the rail, or the rail may be made of metallic material. When the easel has a rail, the first and second mounts further may have a grooves sized to fit over the rail.

### BRIEF DESCRIPTION OF FIGURES

FIG. 1 is a perspective view of one embodiment of an easel of the present invention.

FIG. 2 is a front view of the embodiment of FIG. 1.

FIG. 3 is a back view of the embodiment of FIG. 1.

FIG. 4 is a front perspective view of a carriage mount in accordance with one embodiment of the easel of the present invention.

FIG. 5 is rear perspective view of a carriage mount in accordance with one embodiment of the easel of the present invention.

FIG. 6 is a cross sectional view of the carriage mount of FIG. 4.

FIG. 7 is an exploded view of one embodiment of a variable strength magnet in accordance with one embodiment of the present invention.

FIG. 8 is an exploded view of another embodiment of a variable strength magnet in accordance with one embodiment of the present invention.

FIG. 9 is a cross sectional view of the variable strength magnet of FIG. 8.

### DETAILED DESCRIPTION OF THE INVENTION

Before the present system and methods of use thereof for an easel are disclosed and described, it is to be understood that this invention is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present invention will be determined by the appended claims and equivalents thereof.

As used herein, “comprising,” “including,” “containing,” “characterized by,” and grammatical equivalents thereof are inclusive or open-ended terms that do not exclude additional, unrecited elements or method acts.

As used herein, “about” means reasonably close to, a little more or less than the stated number or amount, or approximately.

As used herein, “exemplary” means serving as an example of. The use of the term “exemplary” herein in connection with a particular embodiment is not to be construed as the particular embodiment being preferred over any other embodiment.

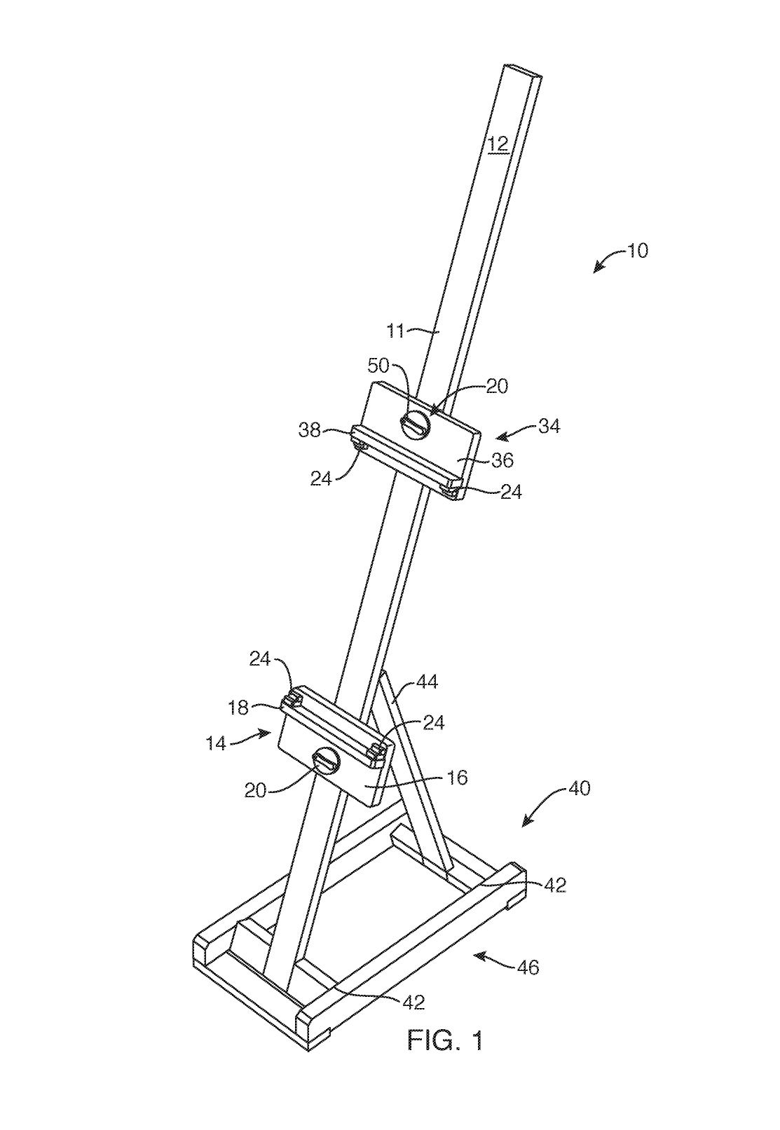

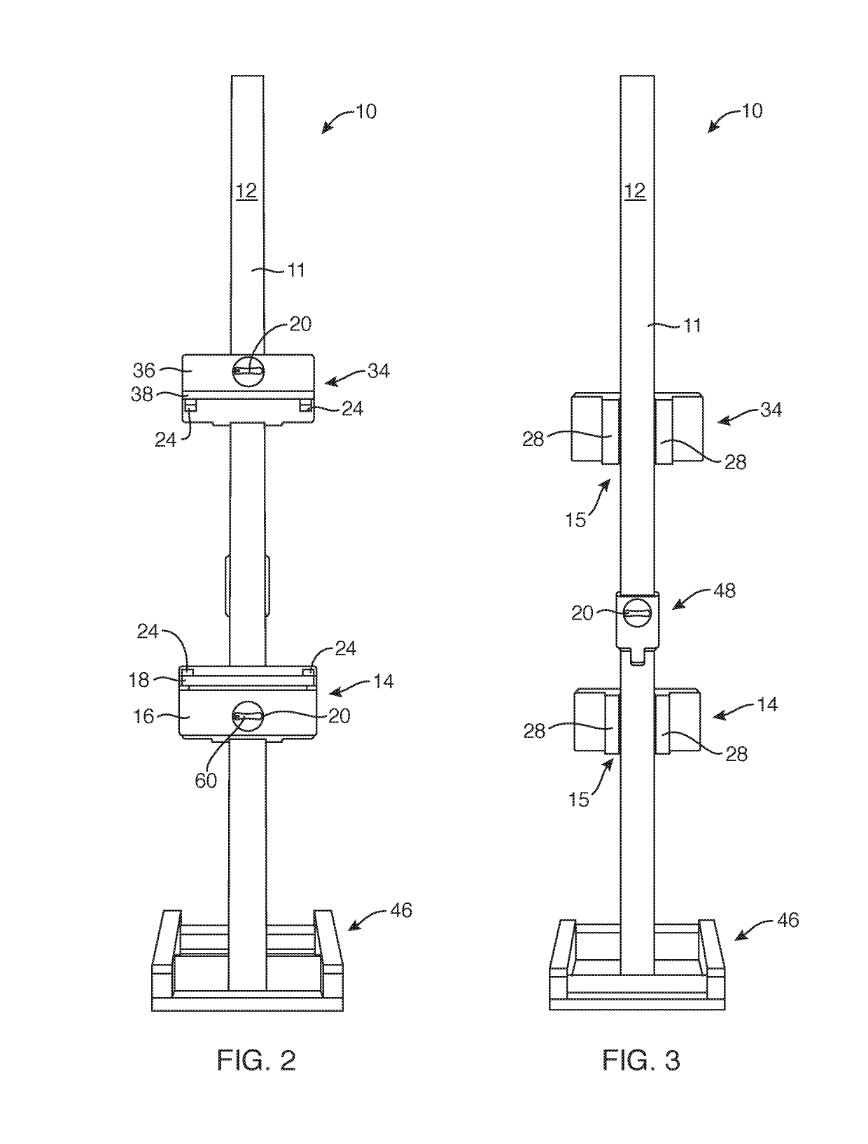

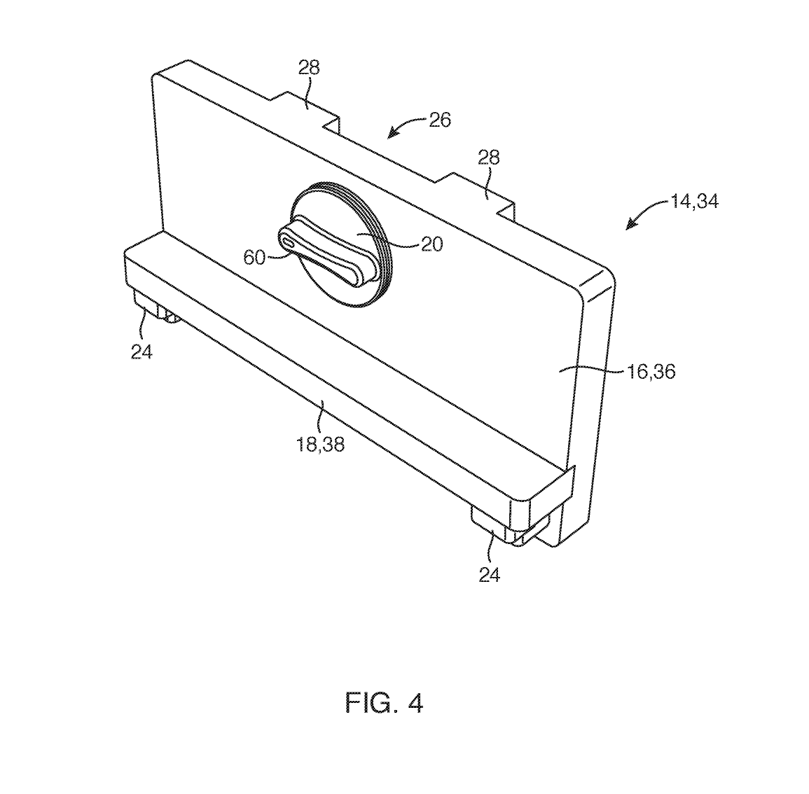

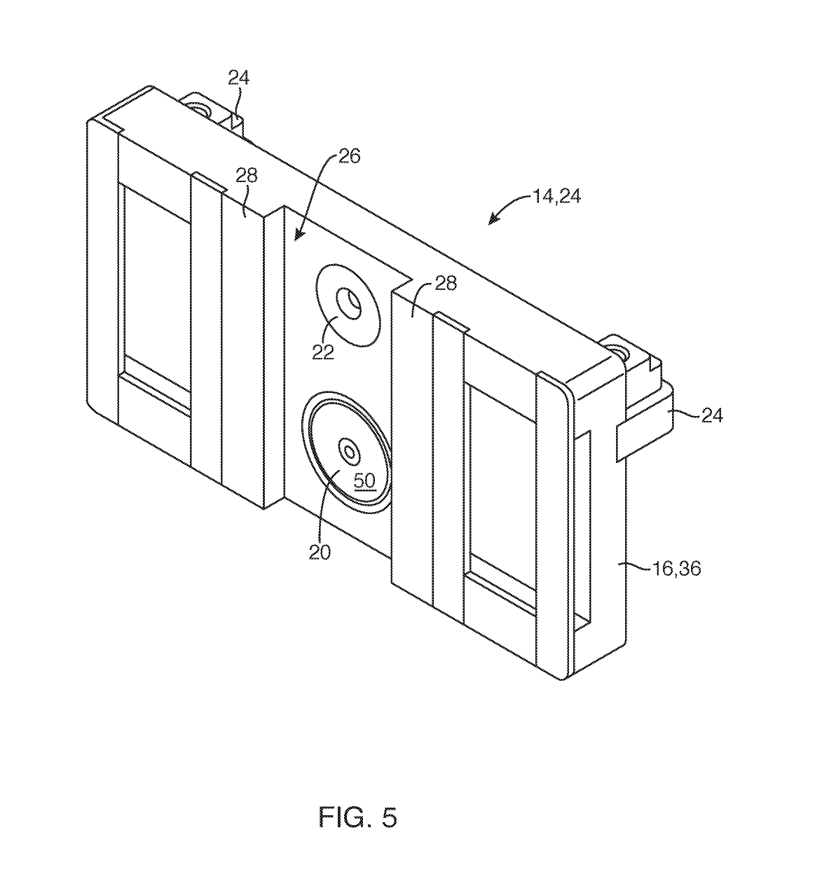

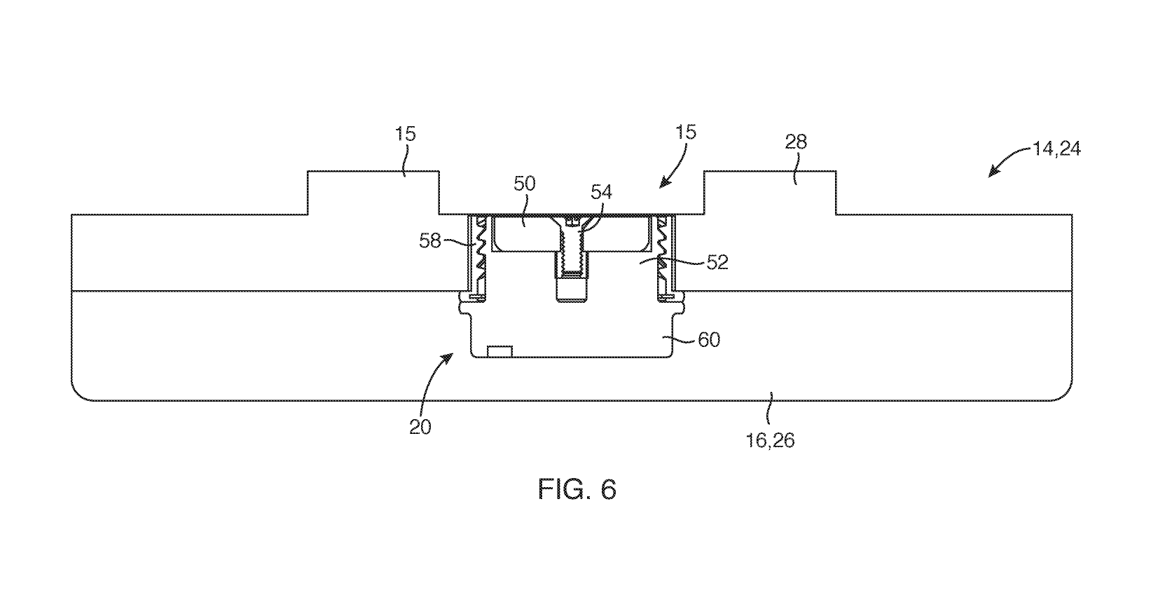

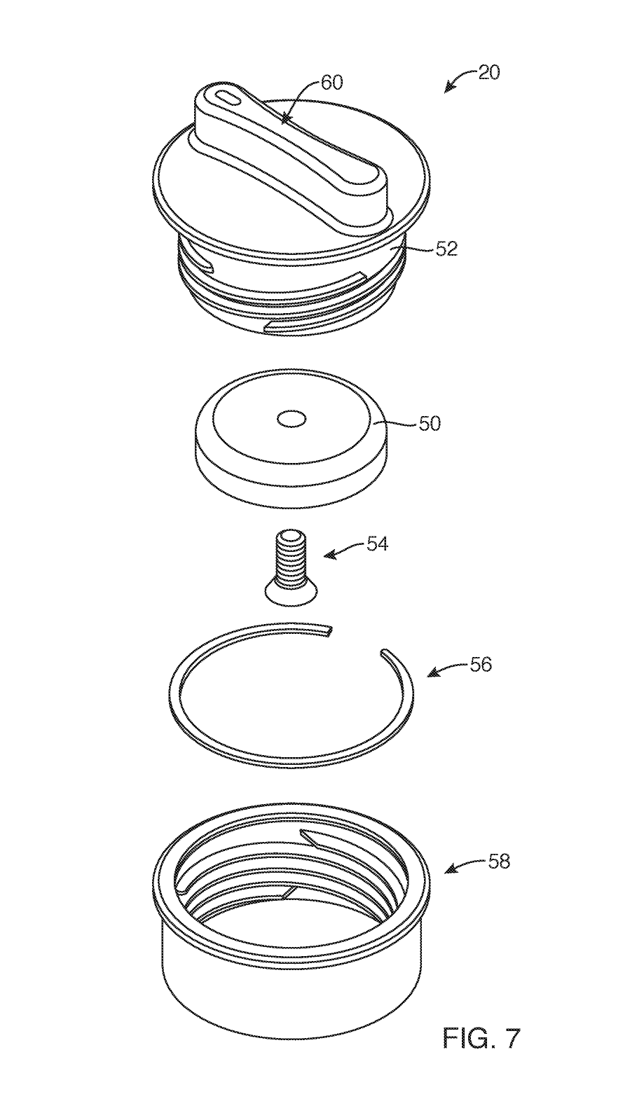

Referring to FIGS. 1-6 an exemplary embodiment of an easel 10 is presented. The easel 10 may have to a surface 12 that is attracted to a magnet. In certain embodiments, the surface 12 is part of the easel 10. In other embodiments the surface 12 may be a standalone surface such as a sheet of metal, a metal door, a chalkboard, a whiteboard, and the like. Any surface that may be magnetized or to which magnets will attach may be used. In the illustrated embodiment 10, the surface 12 is on a rail 11. The surface 12 is wrapped around the rail 11, but it may be embedded in the rail 11 or attached only to one or more sides of the rail 11.

A first mount 14 is configured with a mount body 16 and a mount ledge 18 attached to the mount body 16. The mount body 16 contains magnets 20, 22 that secure the first mount 14 to the surface 12. Alternatively, if the surface 12 is magnetized, the first mount 14 may have a magnet or metal that is attracted to the surface 12. The first mount 14 can be configured with a ledge 18 on which a canvas or other art media may be placed. Holders 24 may be on the ledge 18 for further securing the edge of the art medium. Holders 24 may be rubber or silicon pads, felt pads, hook and loop fasteners (Velcro), dimpled metal, sandpaper and the like.

A second mount 34 may also be provided to further secure the art work. The first mount 14 may be positioned on the bottom of the art medium and the second mount 34 on the top of the art medium. In certain embodiments, the first mount 14 or the second mount 34 may be fixed or movable. If only one mount 14, 34 is fixed, the easel 10 may be adjusted for media of differing sizes by moving the other mount 14, 34. In other configurations, both mounts 14, 34 are movable, and the easel 10 may be adjusted for differing media sizes by moving one or both mounts 14, 34 along the rail 11.

Like the first mount, the second mount 34 has a body 36 and a ledge 38 attached to the body 36. The body 36 is configured with magnets 20, 22 that will removably attach the second mount 34 to the surface 12. Alternatively, if the surface 12 is magnetized, the second mount 16 may be a non-magnetized metal that is attracted to the surface 12. Holders 24 on the second mount ledge 38 may be used as on the first mount ledge 18.

To further stabilize the artwork, the easel may include a rail 11. The rail 11 can be an integral part of the part of the easel 10 as illustrated. Alternatively, the rail 11 may be removably attached to a surface such as a metal door, a chalk board, a white board, etc. by for example magnets.

When a rail 11 is used, the mounts 14, 34 may include grooves 15 that are configured to fit over the rail 11. The grooves 15 may be formed by flanges 28 extending from the mount bodies 16, 36. Alternatively, the grooved 15 may be molded or cut into the mount bodies 16, 36. The rail 11 may be made of one or more sections allowing the easel 10 to be configured to hold large canvases while being shipped or stored compactly. For example, the rail 11, may be configured, to have an extension added to the top of the rail 11.

In certain configurations the rail 11 may be magnetized or have magnets embedded therein. In these configurations, the mounts 14, 34 may be metal or have a metal surface that rides upon the rail thereby being attachable to the rail. If a thicker canvas is used, the easel 10 may include mount extenders that can be added to the mounts 14, 34 to extent its outward reach.

Some media like boards and large canvases may be heavy. In these instances additional mounts 14, 34 may be used to further support the medium. Thus the easel 10 may include 2 or more bottom mounts or two or more top mounts that may ride upon two or more rails 11. Alternatively mount stabilizers may be placed adjacent to the mounts 14, 34 to give additional support to a heavy art work.

To further stabilize the mounts 14, 34 the mount bodies 16, 36 may include two magnets 20, 22. One or both of the magnets within the first and second mounts 14, 34 may be fixed strength magnets 22 that have no means for varying the magnetic field exerted on the metallic surface 12. Alternatively, one or more of the magnets 20, 22 may be variable strength magnets that have means for varying the strength of the magnetic field exerted on metallic surface 12. Such variable strength magnets may be electromagnets or have means for cancelling the magnetic field.

In certain configurations, the variable strength magnets for allow for the magnet 50 to be mechanically separating the magnet from the metallic surface such as the magnets 20 and 120. Such variable strength magnets 20, 120 may have a magnet 50 attached to a threaded stem 52 and a threaded housing 58 for receiving the threaded stem 52. The magnetic field exerted on the metallic surface 12 may be varied by turning the magnetic stem 52 to separate the magnet 50 from the metallic surface 12.

In some embodiments, the easel system 10 may include accessories for holding devices useful for an artists. Such accessories can be configured to use magnets such as those illustrated for the mounts 14, 34 with arms extending outwardly from a rail 11 if used or directly attachable to a large metallic surface. Such accessories and accessory holders may include a tablet holder, a paint brush holder, a paper towel holder, and other accessories that are used by artists. These accessories can be attached to the surface 12 by magnets.

A user of the easel may slide mounts 14, 34 and the rail 11 on the surface 12 without removing the mounts 14, 34 from the surface 12. In this way the easel system 10 can be reconfigured to accommodate the medium being used and the preferences of the artist. When accessories are used, the artist may also slide them on the metallic surface.

The magnets 20, 22 can be embedded in the rail 11, the mounts 14, 34, and the accessories. Such magnets are known in the art. By placing a magnet toward the edge of the mount body 16, 36 distal from the ledge 18, 38, the mounts 14, 34 can be removed from the surface by tipping the mount toward the magnets 20 and thereby leveraging the mount away from the surface 12.

Alternatively variable strength magnets may be used. Such variable magnets may use one magnet to enhance or eliminate the magnetic field of the other by switching the physical orientation of the magnet. Other examples of variable strength magnets may use electromagnets or mechanical means such as levers, springs, or switches to physically move the position of the magnet away from the surface 12.

The rail 11 may be hingedly attached to a base 40. The base may be of any of a variety of configurations, but the hinges 42 will allow the base to be folded for shipment, movement, or storage. A rear support 44, may be used to create a sturdy triangular base 40 comprised of the rail 11, a rear support 44, and a bottom, 46. A hinged support flap 48 may be configured to attach the rear support 44 to the rail 11. When the rail 11 is made of metal, wrapped with metal or is otherwise attracted to a magnet, a magnet 20 may be in the body of the flap 48. Such magnet 20 may be a variable strength magnet.

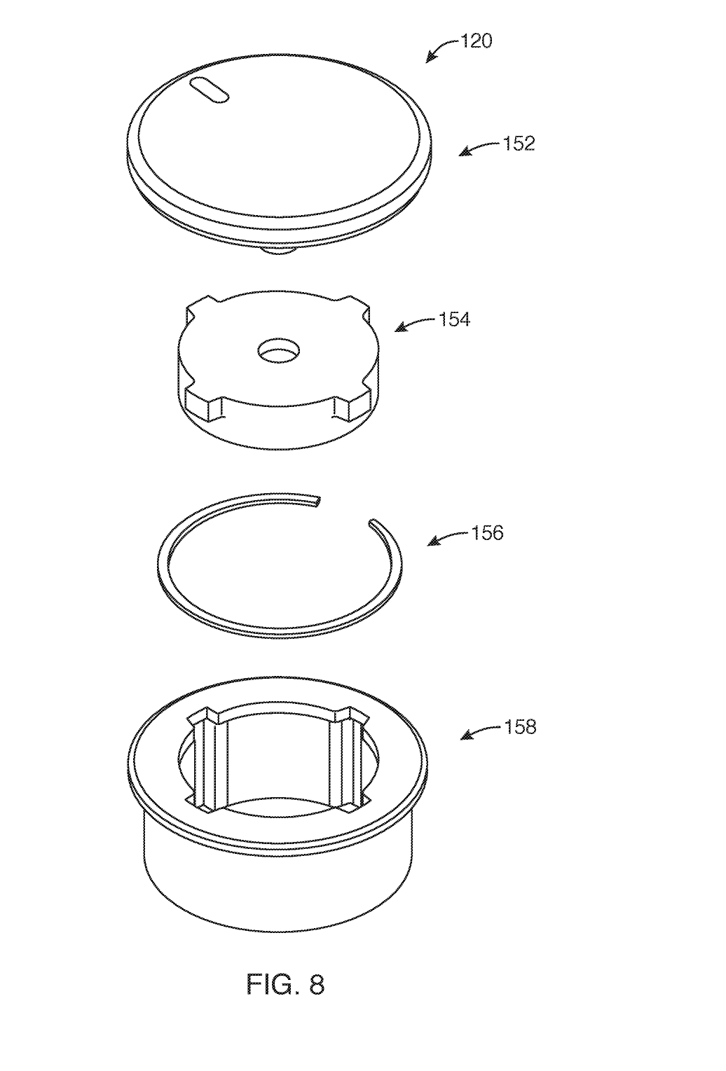

Referring to FIG. 7, an exploded view of a variable strength magnet 20 is presented. The variable magnet 20 has a magnet 50 that is attached to a threaded stem 52 by means of a screw 54. It will be appreciated that other attachment means may be used such as rivets, adhesives, molding the magnet into the stem 52 and the like. A stop ring 56 may be included to prevent the over tightening of the variable magnet assemble 20. The threaded stem 52 is configured to be received in a housing 58. Such housing 58 may be separate from the part that contains it such as a mount 14, 36 or flap 48 or may be an integral part of such. The strength of a magnetic field exerted by the magnet 50 on a metal surface can be varied by turning the stem 52 by way of a knob 60 or other means. As the magnet 50 approaches the surface the strength of the field on the surface will increase and likewise as the magnet 50 is mechanically removed from the surface by way of turning the stem 52 in the opposite direction the field will decrease. Thus a user can secure a very strong magnet to a surface or remove it by the twist of the knob 60. It will be appreciated that such variable magnets such as those disclosed herein can be used on a variety of surface such as sheet metal, doors, automobiles, air craft, drones, and the like.

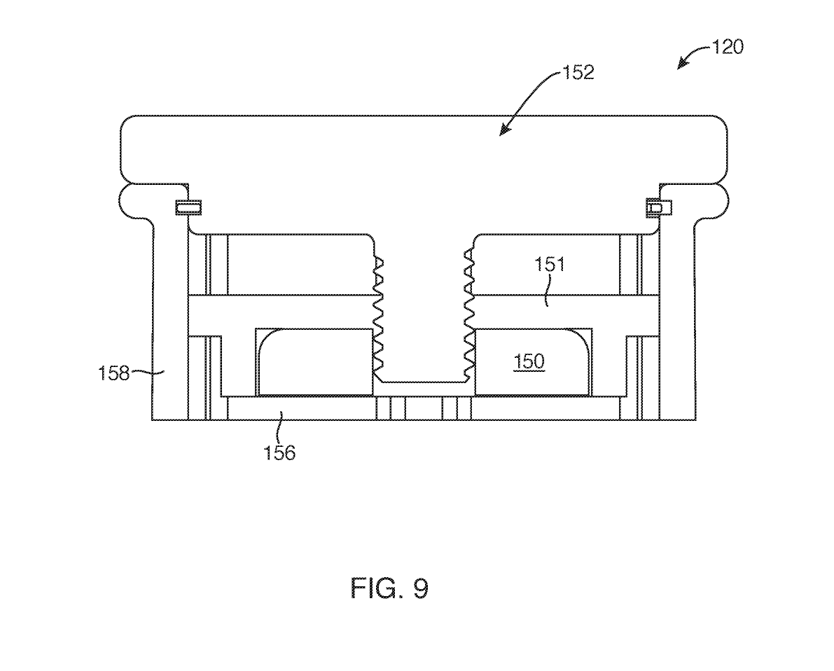

Referring now to FIGS. 8 and 9 an alternative embodiment of a variable magnet 120 is shown. A magnet 150 is insertable within a housing 158. A stopper ring 156 can be used to prevent over tightening or loosening the device 120. A threaded stem 152 can be used to raise and lower the magnet 150.

The housing of either variable magnet 20, 120 can be an integral part of the device on which the magnet is used or may be a separate piece attached to the device. For example in the case of the easel of the present invention, the housing may be molded or machined into the mount body 16, 36. Alternatively the housing 58, 158 can be formed separately and securing within the mount body by means of adhesives, fasteners, friction fits, and the like. While the variable strength magnets 20, 120 are shown used with the mounts or other components of the easel. It will be appreciated that they may have other uses for removably attaching other objects to metal surfaces. Accordingly they may be used to secure signs to the exterior of an automobile, secure holiday decorations, to a metallic door, or many other uses.

1. An easel comprising:
a first mount comprising a mount body and a mount ledge, the mount body comprising a first magnet for attaching the first mount to a metallic surface and the mount ledge configured to hold the edge of an artistic medium.

2. The easel of claim 1, wherein the first mount comprises a second magnet within the mount body.

3. The easel of claim 1, further comprising a second mount comprising a mount body and a mount ledge, the mount body comprising a first magnet for attaching the second mount to the metallic surface and the mount ledge configured to hold the second edge of the artistic medium.

4. The easel of claim 3, wherein the second mount further comprises a second magnet within the mount body.

5. The easel of claim 3, wherein the first and second mounts each further comprise second magnets within the mount body, wherein first magnets are a fixed strength magnets and the second magnets are a variable strength magnets.

6. The easel of claim 5, wherein the variable strength magnets each comprise a magnet attached to a threaded stem and a housing threaded housing for receiving the threaded stem.

7. The easel of claim 3, wherein the easel further comprises a rail, the first and second mounts further comprising a groove sized to fit over the rail.

8. The easel of claim 7, wherein the rail comprises the metal surface.

9. The easel of claim 3, wherein the first and second mounts mounts further comprise a holder for securing the edge of medium thereon.

10. The easel of claim 9 wherein the holder is selected from the group consisting of rubber or silicon pads, felt pads, Velcro, dimpled metal, and sandpaper.

11. An easel comprising:
a top mount comprising a mount body and a mount ledge, the mount body comprising a first magnet for attaching the first mount to a metallic surface and the mount ledge configured to hold the edge of an artistic medium; and
a bottom mount comprising a mount body and a mount ledge, the mount body comprising a first magnet for attaching the second mount to the metallic surface and the mount ledge configured to hold the second edge of the artistic medium.

12. The easel of claim 11, wherein the top and bottom mounts each further comprise second magnets within the mount body, wherein first magnets are a fixed strength magnets and the second magnets are a variable strength magnets.

13. The easel of claim 12, wherein the variable strength magnets each comprise a magnet attached to a threaded stem and a housing threaded housing for receiving the threaded stem.

14. The easel of claim 13, wherein the easel further comprises a rail, the top and bottom mounts further comprising a groove sized to fit over the rail.

15. The easel of claim 14, wherein the rail comprises the metal surface.

16. A device for varying the strength of a magnet comprising:
a magnet;
a housing having a first end and a second end;
and means for moving the magnet from a position proximate the first end of the housing toward the second end of the housing.

17. The device of claim 16, further comprising threads within the housing for receiving therein a threaded stem having a first end and a second end, the magnet attached to the first end of the threaded stem.
